(19) United States
(12) Patent Application Publication
(10) Pub. No.: US 2009/0286907 A1
(43) Pub. Date: Nov. 19, 2009

(54) Fumaric Acid/Diol Polyesters and Their Manufacture and Use

(76) Inventors: Mark W. Beltz, Decatur, IL (US); Susan Butler, Decatur, IL (US); Mark Daniel Cassidy, Decatur, IL (US); Timothy Russell Cooper, Decatur, IL (US); Erin S. Criswell, Cambridge, MA (US); Michael D. Harrison, Decatur, IL (US); Sarah Massey, Arthur, IL (US)

Correspondence Address: WILLIAMS, MORGAN & AMERSON, P.C., 10333 RICHMOND, SUITE 1100, HOUSTON, TX, 77042, US

(21) Appl. No.: 12/355,017

(22) Filed: Jan. 16, 2009

Related U.S. Application Data
(60) Provisional application No. 61/022,884, filed on Jan. 23, 2008.

(51) Int. Cl. C08L 67/02; C08G 63/12; C08L 3/02; B29C 47/00

(52) U.S. Cl. 524/47; 528/306; 524/604; 525/444; 264/176.1

(57) ABSTRACT

We disclose a composition containing a polyester comprising about 1 mole part diol units and from about 0.98 mole parts fumaric acid units to about 1.01 mole parts fumaric acid units. In one embodiment, the diol units are 1,3-propanediol units or 1,2-propanediol units. In one embodiment, the polyester is blended with polylactide. In another embodiment, the composition is in a form selected from the group consisting of a plate, a tray, a bowl, a cup, a bowl lid, a cup lid, a fork, a spoon, a knife, a jewel case, and a packaging article. We also disclose a method of manufacturing the composition. The method includes combining about 1 mole part diol, from about 0.98 mole parts fumaric acid to about 1.01 mole parts fumaric acid, and from about 0.0002 mole parts to about 0.0020 mole parts of a polyesterfication catalyst, to yield a combination of diol and fumaric acid; maintaining the combination of diol and fumaric acid under an inert atmosphere at a temperature from about 130° C. to about 190° C. for at least about 2 hr, to yield a molten combination; maintaining the molten combination under vacuum at a temperature from about 130° C. to about 190° C. for at least about 6 hr, to yield a molten polyester; and cooling the molten polyester, to yield the polyester.

This application claims priority from U.S. provisional patent application Ser. No. 61/022,884, filed on Jan. 23, 2008, which is incorporated herein by reference.

### BACKGROUND OF THE INVENTION

The present invention relates generally to the field of polymer chemistry. More particularly, it concerns polyesters, especially biomaterial polyesters, their manufacture, and use.

### SUMMARY OF THE INVENTION

In one embodiment, the present invention relates to a composition containing a polyester comprising about 1 mole part diol units and from about 0.98 mole parts fumaric acid units to about 1.01 mole parts fumaric acid units. In one embodiment, the diol units are selected from the group consisting of 1,3-propanediol units, 1,4-butanediol units, and 1,2-propanediol units. In another embodiment, the composition is in a form selected from the group consisting of a plate, a tray, a bowl, a cup, a bowl lid, a cup lid, a fork, a spoon, a knife, a jewel case, and a packaging article.

In one embodiment, the present invention relates to a method of manufacturing a composition containing a polyester comprising about 1 mole part diol units and from about 0.98 mole parts fumaric acid units to about 1.01 mole parts fumaric acid units. The method includes combining about 1 mole part diol, from about 0.98 mole parts fumaric acid to about 1.01 mole parts fumaric acid, and from about 0.0002 mole parts to about 0.0020 mole parts of a polyesterfication catalyst, to yield a combination of diol and fumaric acid; maintaining the combination of diol and fumaric acid under an inert atmosphere at a temperature from about 130° C. to about 190° C. for at least about 2 hr, to yield a molten combination; maintaining the molten combination under vacuum at a temperature from about 130° C. to about 190° C. for at least about 18 hr, to yield a molten polyester; and cooling the molten polyester, to yield the polyester.

### DESCRIPTION OF ILLUSTRATIVE EMBODIMENTS

In one embodiment, the present invention relates to a composition containing a polyester comprising about 1 mole part diol units and from about 0.98 mole parts fumaric acid units to about 1.01 mole parts fumaric acid units.

Fumaric acid is an organic diacid having the structure:

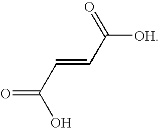

A “fumaric acid unit” is a portion of a polyester which is derived from condensation of one molecule of fumaric acid with one or more alcohols.

“Diol” is used herein to refer to any organic molecule containing two —OH groups. A “diol unit” is a portion of a polyester which is derived from condensation of one molecule of a diol with one or more organic acids. In one embodiment, the diol is selected from the group consisting of ethylene glycol, 1,4-butanediol, 1,2-propanediol, isosorbide, and 1,3-propanediol. In a further embodiment, the diol is selected from the group consisting of 1,3-propanediol:

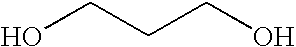

and 1,2-propanediol:

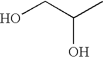

and the diol units are selected from the group consisting of 1,3-propanediol units, 1,4-butanediol units, and 1,2-propanediol units.

In one embodiment, the polyester has essentially the structure:

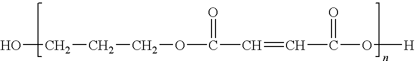

The polyester can be prepared by techniques known in the art. Reaction conditions that have been found to produce polyesters having properties desirable for certain uses, as well as those uses, will be discussed below. The conditions of the polyesterification reaction can be selected to yield a polyester having any of a number of values for any of a number of physical properties. One such physical property is the molecular weight of the polyester. As is known in the polymer arts, a polyester's molecular weight can be defined as the weight-average molecular weight (MWw) or the number-average molecular weight (MWn). In one embodiment, the polyester has a MWn from about 2 kDa to about 50 kDa. In a further embodiment, the polyester has a MWn from about 13 kDa to about 50 kDa.

Another such physical property is the melt flow index (MFI) of the polyester. In one embodiment, the polyester has an MFI when analysis is performed at 145° C. of less than about 5 g/10 min.

In addition to the polyester, the composition can contain other components. In one embodiment, the composition contains at least one component selected from the group consisting of a plasticizer, a pigment, and an antioxidant. The composition can comprise two or more of these components.

The plasticizer can be any material that renders the composition less brittle than it would be in the absence of the material. In one embodiment, the plasticizer is selected from the group consisting of polyethylene glycol and sorbitol.

The polyester, in dry, solid form, typically has a white color. If the composition is intended for uses where a different color is desired, a pigment can be included. Any pigment known in the art for use in a polyester composition can be used.

The fumaric acid units contain a carbon-carbon double bond. This double bond is susceptible to oxidation, which can lead to degradation of the polyester molecule or cross-linking of polyester molecules. The antioxidant can be any material that renders the fumaric acid units less susceptible to oxidation. In one embodiment, the antioxidant is selected from the group consisting of tert-butyl hydroquinone, 2,5-di-tert-butyl hydroquinone, and α-tocopherol (vitamin E). One commercially available formulation of α-tocopherol is Irganox® E201 (Ciba Specialty Chemicals, Inc., Tarrytown, N.Y.).

The proportions of the polyester and the at least one component selected from the group consisting of a plasticizer, a pigment, and an antioxidant are not critical. In one embodiment, the composition contains from about 5 weight parts to about 90 weight parts polyester; if included, from about 0.1 weight parts to about 20 weight parts plasticizer; if included, from about 0.1 weight parts to about 1 weight part pigment, and, if included, from about 0.002 weight parts to about 1 weight part antioxidant. In a further embodiment, the plasticizer is a polyethylene glycol and the antioxidant is 2,5-di-tert-butyl hydroquinone.

The composition can also comprise other polymers in addition to the polyester in the form of a non-coreacted blend. A non-coreacted blend can be identified by contacting the putative blend with a solvent in which one of the polymers is soluble and the other is not; if greater than or equal to 5 wt % of the soluble polymer is removed from the putative blend, a non-coreacted blend is indicated. In some situations, a non-coreacted blend can be identified as having two glass transition temperatures (Tgs) as measured by differential scanning calorimetry (DSC), although this technique may not be effective in situations in which the Tgs of the two polymers are close enough to have overlapping DSC peaks.

Although the previous paragraph referred to a non-coreacted blend of two polymers, non-coreacted blends of three or more polymers are also contemplated. The person of ordinary skill in the art, having the benefit of the present disclosure, can readily identify non-coreacted blends of three or more polymers as a matter of routine experimentation.

In one embodiment, the composition further comprises a starch. In one embodiment, the composition further comprises polylactic acid or polylactide. The proportions of the polyester and the starch, polylactic acid, or polylactide are not critical.

In one embodiment, the composition contains from about 5 weight parts to about 90 weight parts polyester and from about 10 weight parts to about 95 weight parts of a second polymer selected from the group consisting of starch, polylactic acid, and polylactide. In a further embodiment, the composition contains from about 5 weight parts to about 50 weight parts polyester and from about 50 weight parts to about 95 weight parts polylactic acid or polylactide. In still a further embodiment, the composition contains about 50 weight parts polyester and about 50 weight parts polylactic acid or polylactide. In another further embodiment, the composition contains from about 10 weight parts to about 30 weight parts polyester and from about 70 weight parts to about 90 weight parts polylactic acid or polylactide.

In embodiments wherein the composition comprises a polyester derived at least in part from 1,2-propanediol units, the composition can further comprise a gelation inhibitor. In one embodiment, the gelation inhibitor is 2,5-di-tert-butyl hydroquinone.

In another embodiment, the composition contains from about 10 weight parts to about 85 weight parts polyester, from about 10 weight parts to about 70 weight parts pearl starch, and from about 5 weight parts to about 20 weight parts sorbitol. In a further embodiment, the composition contains from about 30 weight parts to about 50 weight parts polyester, from about 30 weight parts to about 50 weight parts pearl starch, and from about 15 weight parts to about 20 weight parts sorbitol.

In one embodiment, at least about 50 wt % of the diol and fumaric acid, and their corresponding units in the polyester, are derived from biomass. “Derived from biomass” means that substantially all the carbon atoms in the diol and the fumaric acid were fixed from atmospheric carbon dioxide within about one hundred years before production of the polyester, such as within about ten years, about two years, or about one year. For example, fumaric acid can be extracted from fumitory (Fumaria officinalis), bolete mushrooms (e.g., Boletus fomentarius var. pseudo-igniarius), lichen, and Iceland moss, or it can be produced by the oxidation of furfural, which reactant can be derived from bran, corn cob, or wood. An exemplary diol, 1,3-propanediol, can be produced by fermentation of a genetically engineered E. coli on a refined corn syrup.

In one embodiment, the present invention relates to a method of manufacturing a composition containing a polyester comprising about 1 mole part diol units and from about 0.98 mole parts fumaric acid units to about 1.01 mole parts fumaric acid units. The method includes combining about 1 mole part diol, from about 0.98 mole parts fumaric acid to about 1.01 mole parts fumaric acid, and from about 0.0002 mole parts to about 0.0020 mole parts of a polyesterfication catalyst, to yield a combination of diol and fumaric acid; maintaining the combination of diol and fumaric acid under an inert atmosphere at a temperature from about 130° C. to about 190° C. for at least about 2 hr, to yield a molten combination; maintaining the molten combination under vacuum at a temperature from about 130° C. to about 190° C. for at least about 18 hr, to yield a molten polyester; and cooling the molten polyester, to yield the polyester.

The diol and the fumaric acid have been described above. The polyesterification catalyst can be any material known in the art for catalysis of esterification. In one embodiment, the polyesterification catalyst is selected from the group consisting of tin(II) chloride, tin(II) octonate, n-butyl stannoic acid, sulfuric acid, p-toluene sulfonic acid, and mixtures thereof.

In one embodiment, an antioxidant is included in the combining step. The antioxidant can be selected from the group consisting of tert-butyl hydroquinone, 2,5-di-tert-butyl hydroquinone, and α-tocopherol (vitamin E, e.g., Irganox® E201). The antioxidant can be included in the combining step in the amount of from about 0.002 mole parts to about 0.020 mole parts.

The combining step can be performed in any appropriate reaction vessel known in the art. The materials can be combined in any order. The result of the combining step is a combination of diol and fumaric acid, with catalyst also being present in the reaction vessel.

After the materials are combined, the combination of diol and fumaric acid is maintained under an inert atmosphere at a temperature from about 130° C. to about 190° C. for at least about 2 hr. In one embodiment, the temperature is from about 130° C. to about 165° C. In a particular embodiment, the temperature is from about 130° C. to about 160° C. In a further embodiment, the temperature is from about 130° C. to about 150° C. It should be borne in mind that electrical heaters can produce hot spots having local temperatures greater than about 190° C. even if the electrical heater is set to a nominal temperature below about 190° C., 165° C., 160° C., or 150° C. Therefore, it is desirable to heat the reaction vessel non-electrically.

The inert atmosphere can be nitrogen, argon, or a mixture thereof. In one embodiment, the inert atmosphere is nitrogen.

The duration and temperature are typically enough to yield a molten combination, i.e., melted diol and fumaric acid.

The molten combination is then maintained under vacuum at a temperature from about 130° C. to about 190° C. for at least about 6 hr, such as for at least about 18 hr. In one embodiment, the temperature is from about 130° C. to about 165° C. In a further embodiment, the temperature is from about 130° C. to about 150° C. Vacuum will extract product water from the reaction vessel and thereby reduce the rate of decondensation of the polyester back to the diol and the fumaric acid. Vacuum will therefore drive the reaction toward completion. The vacuum maintenance step will yield a molten polyester. Typically the combining, maintaining, and vacuum maintaining steps can be performed in the same vessel, but they need not be. It is desirable that the vessel in which the vacuum maintaining step is performed is air-tight.

The application of certain embodiments of the method, when performed on 1,3-propanediol and fumaric acid, can yield polymers having higher molecular weight and greater linearity than other polymers.

The molten polyester is then cooled, such as to ambient temperature, to yield the polyester. The cooling step can be performed in the reaction vessel or in another vessel.

In one embodiment, the cooling step involves extrusion of the molten polyester to yield a sheet comprising cooled polyester.

The sheet can be produced by any technique known in the art of monolayer or coextrusion. Such techniques include sheet extrusion either as a single extruded layer or a plurality of coextruded layers. In a typical sheet extrusion process, molten material from an extruder flows through a flat die to form a sheet which is passed through a chill roll stack. Chill roll stacks typically consist of at least three cooled rolls. Typically the sheet produced has a thickness of between about 5 mils and about 20 mils.

In another embodiment, the molten polyester is coextruded with a second polymer selected from the group consisting of starch, polylactic acid, and polylactide, as described above. In another embodiment, the molten polyester is coextruded with at least one component selected from the group consisting of a plasticizer, a pigment, and an antioxidant, as described above.

In embodiments wherein the polyester is present in a sheet, the sheet can be stored until later use. In one embodiment, the sheet is molded to form a plate, a tray, a bowl, a cup, a bowl lid, a cup lid, a fork, a spoon, a knife, a jewel case, or a packaging article. Molding techniques are known in the art.

In one embodiment, the composition is heat resistant. “Heat resistant” herein means the composition will have a heat deflection temperature (HDT), as can be measured according to ASTM Method D 648-06, of at least about 60° C. A heat resistant product, such as a plate, a tray, a bowl, a cup, a bowl lid, a cup lid, a fork, a spoon, a knife, a jewel case, or a packaging article formed from the composition can be used in the packaging of hot foods and beverages or can be readily stored and transported at high temperatures (such as up to about 50° C.), such as those that may prevail inside a shipping container during summer in the southern or western United States and comparable or warmer climates.

Generally, when the composition contains the polyester and polylactic acid or polylactide, the greater the polyester content, the higher the HDT.

In one embodiment, the composition has an HDT value from about 90° C. to about 122° C.

In one embodiment, the composition is flexible. “Flexible” herein means the composition has a flexibility rating of 4 or 5 as measured by the procedure described in Example 2, below.

The composition and packaging articles made therefrom can have use in food contact applications where the temperature of the contents is close to boiling (80-100° C., 212° F.) and where biodegradability and/or renewability is desirable. The composition and packaging articles made therefrom can additionally be used in food contact applications where temperatures are below about 80° C. The composition and packaging articles made therefrom can also find use in non-food applications for plastics which require thermal stability up to about 100° C.

In one embodiment, a polyester derived from the stated compositions can be reacted with a chain extending agent to link one chain to another and/or to alter the physical properties of the polyester. The physical properties that can be altered by the use of a chain extending agent include, but are not limited to, molecular weight and MFI.

The chain extending agent can be any one known to be useful in the art for polyester chain extension. In one embodiment, the chain extending agent is selected from the group consisting of isocyanates, epoxides, acyl chlorides, anhydrides, acrylics, aziridines, phosphate esters, multivalent metals, polyacids, polyols, oxazolines, polymers or copolymers containing any of the foregoing functional groups, and mixtures thereof.

Examples of isocyanate compounds include 4,4′-methylene diphenyl diisocyanate (MDI), toluene diisocyanate (TDI), hexamethylene diisocyanate (HDI or HDMI), isophorone diisocyanate (IPDI), lysine diisocyanate (LDI), trimethylxylene diisocyanate (TMDI or TMXDI), polyisocyanate compounds (such as Desmodur® polyisocyanates manufactured by Bayer A.G), and mixtures thereof.

In one embodiment, the chain extending agent is introduced into a molten polyester. This can be done either in a continuous process such as extrusion or in a batch process such as a batch reactor. The molten polyester can be still molten from its polymerization or can be a remelt of already-formed and cooled polyester.

In one embodiment, a poly(1,3-propylene fumarate) is remelted and held at a temperature above the melting point of the polyester, and below the decomposition temperature thereof, typically not more than about 10° C. above the melting point of the polyester, such as about 145° C. for the duration of the reaction. HMDI (16.43 g, 0.098 mol) can be added to the molten polyester and the reaction continued for a desired length of time, such as about 30 min. The resulting polymer may exhibit about a two-fold increase in molecular weight (for example, Mn increasing from about 6,000 to about 12,000) and a concomitant increase in viscosity of the molten material. The resulting polymer may also exhibit a significant improvement in mechanical properties over the non-chain-extended polymer, including improved impact strength, tensile strength, and elongation until break. A significant increase in flexibility may also be observed.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

1,3-propanediol (2622.2 g, 34.462 mol), 4000.00 g (34.462 mol) of fumaric acid, and 4.00 g (0.0175 mol) of tin (II) chloride (0.07 wt %) were charged into a 6-L resin kettle equipped with a mechanical stirrer, heating mantle with thermocouple temperature control, nitrogen inlet, and condenser with a distillation storage head. When charging the monomers, liquid monomers or the lowest-melting-point monomers were loaded first into the reactor to help solubilize the other monomers and prevent charring. The polymerization was then heated to 160° C. under a low nitrogen flow. After approximately 6 h, the mixture was at 160° C. and was held at that temperature for twelve hours. At this point, approximately 1160 mL of water had been collected in the storage head. The water was drained from the storage head. The nitrogen inlet was replaced with a stopper, the oil bubbler was removed, and a vacuum connection put in its place. The vacuum was then turned on and adjusted to 5 in Hg using a needle valve. The polymerization started to reflux vigorously. The vacuum was held at 5 in Hg until the refluxing subsided (˜15 min). The vacuum was then increased to 10 in Hg and allowed to reflux vigorously again. The process was repeated until a final vacuum of at least 25 in Hg was reached. The polymerization was then continued for an additional 18-20 h at 160° C. and 25 in Hg. The water was again drained from the storage head (˜20 mL, total of 1180 mL). The polymerization vessel was then taken apart and the molten polymer was poured into four silicon baking dishes and cooled. The polymer was weighed, 4436.39 g (82% yield), broken up, and stored. Samples were removed for testing by differential scanning calorimetry (DSC), thermogravimetric analysis (TGA), and GPC.

The cooled product underwent DSC, which determined the polymer has a glass transition temperature (Tg) of −11° C., a strong melting point at 137° C., a MFI of 1.2 at 139.2° C. and 2.16 kg weight and is stable to 340° C.

### Example 2

A material consisting of poly(propylene fumarate) (PPF) and polylactide (PLA) at a ratio of 1 to 1 (wt/wt) was physically blended using a Leistritz 18 mm counter-rotating twin-screw extruder model ZSE-18/HP with the following screw configuration:

GFF-2-30-90/GFA-2-30-60/GFA-2-20-30/KB-2-20-30-1.5/KB-2-20-30-1.5/GFA-2-20-60/GFA-2-20-30/GFA-2-20-60/GFA-2-20-60/GFA-2-15-20/GFA-2-30-60/KB-2-20-60-1.5/KB-2-20-90-1.5/GFA-2-15-60/GFA-2-30-30/GFA-2-30-60/Exit.

The zone temperatures of the extruder were set accordingly: Z1-107° C.; Z2-117° C.; Z3-122° C.; Z4-140° C.; Z5-140° C.; Z6-140° C.; Z7-140° C.; Z8-140° C. The screw speed was kept at 140 RPM.

Based on initial feed the final blend composition consisted of 49.96% PPF, 49.96% PLA and 0.08% di-tert-butylhydroquinone (DTBHQ).

Flexibility Test

The flexibility rating is based on a scale from 1 to 5, as measured according to the following protocol. A test specimen having dimensions of 4.00 in ×0.5 in ×0.017 in (length×width×height) is grasped at each end (the edges separated by the length) and bent back on itself. The angle formed by the ends of the specimen at the moment when the material breaks or is permanently deformed is measured. If the angle is from 135° to 180°, the flexibility rating is 1; for angles from 90° to 135°, the flexibility rating is 2; for angles from 45° to 90°, the flexibility rating is 3; for angles from greater than 0° to 45°, the flexibility rating is 4; and if the ends of the specimen can be folded onto each other (i.e., to touching) without the specimen breaking or being permanently deformed, the flexibility rating is 5.

Heat Deflection Temperature (HDT) Test

ASTM D 648-06 method A, which is a standard method for deflection temperature of plastics under flexural load, was used.

Results:

Using the above HDT and flexibility test the following results were obtained for the polymer of the example and two comparative polymers, a polylactide, HM 1011 (Hycail) and a high-impact polystyrene (HIPS), Pet. 825E, (Total):

| Polymer | HDT (° C.) | Flexibility Test |
|---|---|---|
| PLA (Hycail HM 1011) | 52° C. | 5 |
| HIPS (Total Pet. 825E) | 92° C. | 5 |
| PPF/PLA blend (Example 2) | 106° C. | 4 |

### Example 3

Ethylene glycol (2088.0 g, 33.645 mol), 3905.0 g (33.645 mol) of fumaric acid, 29.97 g (0.05 wt %) of α-tocopherol, and 3.35 g (0.0148 mol) of tin (II) chloride (0.05 wt %) were charged into a 6-L resin kettle equipped with a mechanical stirrer, heating mantle with thermocouple temperature control, nitrogen inlet, and condenser with a distillation storage head. When charging the monomers, liquid monomers or the lowest-melting-point monomers were loaded first into the reactor to help solubilize the other monomers and prevent charring. The polymerization was then heated to 160° C. under a low nitrogen flow. After approximately 6 h, the mixture was at 160° C. and was held at that temperature for twelve hours. At this point, approximately 920 mL of water had been collected in the storage head. The water was drained from the storage head. The nitrogen inlet was replaced with a stopper, the oil bubbler was removed, and a vacuum connection put in its place. The vacuum was then turned on and adjusted to 5 in Hg using a needle valve. The polymerization started to reflux vigorously. The vacuum was held at 5 in Hg until the refluxing subsided (˜15 min). The vacuum was then increased to 10 in Hg and allowed to reflux vigorously again. The process was repeated until a final vacuum of at least 25 in Hg was reached. The polymerization was then continued for an additional 18-24 h at 160° C. and 29 in Hg. The water was again drained from the storage head (˜20 mL, total of 940 mL). The polymerization vessel was then taken apart and the molten polymer was poured into four silicon baking dishes and cooled. The polymer was weighed, 4572 g (96% yield), broken up, and stored. Samples were removed for testing by differential scanning calorimetry (DSC).

The cooled product underwent DSC, which determined the polymer has a glass transition temperature (Tg) of 16.8° C., and a melting point (Tm) at 88.7° C.

### Example 4

1,4-Butanediol (3060.0 g, 33.951 mol), 3941.0 g (33.951 mol) of fumaric acid, 35.0 g (0.05 wt %) of α-tocopherol, and 4.00 g (0.0177 mol) of tin (II) chloride (0.06 wt %) were charged into a 6-L resin kettle equipped with a mechanical stirrer, heating mantle with thermocouple temperature control, nitrogen inlet, and condenser with a distillation storage head. When charging the monomers, liquid monomers or the lowest-melting-point monomers were loaded first into the reactor to help solubilize the other monomers and prevent charring. The polymerization was then heated to 150° C. under a low nitrogen flow. After approximately 6 h, the mixture was at 150° C. and was held at that temperature for 15 hours. At this point, approximately 1000 mL of water had been collected in the storage head. The water was drained from the storage head. The nitrogen inlet was replaced with a stopper, the oil bubbler was removed, and a vacuum connection put in its place. The vacuum was then turned on and adjusted to 5 in Hg using a needle valve. The polymerization started to reflux vigorously. The vacuum was held at 5 in Hg until the refluxing subsided (˜15 min). The vacuum was then increased to 10 in Hg and allowed to reflux vigorously again. The process was repeated until a final vacuum of at least 25 in Hg was reached. The polymerization was then continued for an additional 113 h at 150° C. and 27 in Hg. The water was again drained from the storage head (˜100 mL, total of 1100 mL). The polymerization vessel was then taken apart and the molten polymer was poured into four silicon baking dishes and cooled. The polymer was broken up and stored. Samples were removed for testing by differential scanning calorimetry (DSC).

The cooled product underwent DSC, which determined the polymer has a glass transition temperature (Tg) of −8.6° C., and a strong melting point (Tm) at 134.8° C.

### Example 5

Fumaric Acid (3000 g, 25.8465 mol), 3.0 g, 0.0133 mol of tin (II) chloride, 20 g (0.5 wt %) of α-tocopherol, and 1976.5 g, 25.9757 mol of 1,3-propane diol were charged into a horizontal jacketed reactor equipped with a condenser and nitrogen inlet. The reactor was heated to 148° C. under a low nitrogen purge. After 90 min, the reactor was at 120° C. and the water of polymerizations started to evolve. The polymerization was allowed to continue in this manner for 24 hours at which time the temperature had increased to 148° C. and 700 mL of water had been collected. The vacuum was then turned on and adjusted to 5 in Hg using a needle valve. The polymerization started to reflux vigorously. The vacuum was held at 5 in Hg until the refluxing subsided (˜15 min). The vacuum was then increased to 10 in Hg and allowed to reflux vigorously again. The process was repeated until a final vacuum of at least 25 in Hg was reached. The polymerization ran in this fashion until the amperage on the motor reached 6.6 (˜48 hours). The polymer was then emptied out of the reactor into an aluminum pan and allowed to cool and harden.

The resultant polymer was subjected to DSC analysis and had a Tg of −7.52° C. and a Tm of 139.95° C. The polymer had a MFI of 6.2 g/10 min at 145° C. with a 2.16 kg load.

### Example 6

A sample of poly(1,3-propylene fumarate) (500 g) was slowly added into a batch reactor until fully melted. The melt was maintained, with stirring, at a temperature above the melting point of the polyester, and below the decomposition temperature thereof, typically not more than about 10° C. above the melting point of the polyester, about 145° C. Hexamethylene diisocyanate (HMDI, 16.43 g, 0.098 mol) was added to the molten polyester to perform chain extension of the molten polyester. The reaction continued for about 30 min and was stopped by turning off stirrer and heat. The reactor was taken apart, and the polymer resin poured into a storage vessel.

The resulting polymer exhibited about a two-fold increase in molecular weight (Mn increased from about 6,000 to about 12,000) and a concomitant increase in viscosity of the molten material. The resulting polymer exhibited a significant improvement in mechanical properties over the non-chain-extended polymer, including improved impact strength, tensile strength, and elongation until break. A significant increase in flexibility was observed, with the original polyester exhibiting a flexibility rating of 1, and the final material exhibiting a flexibility rating of 5 as determined according to the test procedure described in Example 2.

### Example 7

A polymerization starting with a set of reactants as described above is performed in a reactor able to handle high viscosity material, able to generate a vacuum of less than 1 mm Hg, and able to remove frictional heat from mixing a viscous material. In such a reactor, the monomers are added and heated to 160° C. to remove 85-90% of the water of condensation. The vessel contents are then put under vacuum by gradually going from atmospheric pressure to 1 mm Hg over a 1 hour period while maintaining the temperature at 160° C. As the viscosity builds during the course of the reaction, the temperature increases due to frictional heating by the stirrer. However, as stated above, the reactor removes the excess heat and maintains the internal polymerization temperature between 163-165° C. until the desired viscosity is reached.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition, comprising:
a polyester comprising about 1 mole part diol units and from about 0.98 mole parts fumaric acid units to about 1.01 mole parts fumaric acid units.

2. The composition of claim 1, wherein the diol units are selected from the group consisting of ethylene glycol units, 1,4-butanediol units, 1,2-propanediol units, isosorbide units, and 1,3-propanediol units.

3. The composition of claim 2, wherein the polyester has a melt flow index (MFI) when analysis is performed at 145° C. of less than about 5 g/10 min.

4. The composition of claim 1, wherein the polyester is present at from about 5 weight parts to about 90 weight parts, and the composition further comprises at least one component selected from the group consisting of from about 0.1 weight parts to about 20 weight parts of a plasticizer, from about 0.1 weight parts to about 1 weight part of a pigment, and from about 0.002 weight parts to about 1 weight part of an antioxidant.

5. The composition of claim 4, wherein the plasticizer is a polyethylene glycol or the antioxidant is α-tocopherol.

6. The composition of claim 1, wherein the polyester is present at from about 5 weight parts to about 90 weight parts, and the composition further comprises from about 10 weight parts to about 95 weight parts of a second polymer selected from the group consisting of starch, polylactic acid, and polylactide.

7. The composition of claim 6, wherein the polyester is present at about 50 weight parts and the second polymer is polylactide and is present at about 50 weight parts.

8. The composition of claim 1, wherein the diol units and the fumaric acid units are derived from biomass.

9. The composition of claim 1, in a form selected from the group consisting of a plate, a tray, a bowl, a cup, a bowl lid, a cup lid, a fork, a spoon, a knife, a jewel case, and a packaging article.

10. A packaging article, comprising:
a composition comprising a polyester comprising about 1 mole part diol units and from about 0.98 mole parts fumaric acid units to about 1.01 mole parts fumaric acid units.

11. The packaging article of claim 10, wherein the diol units are selected from the group consisting of ethylene glycol units, 1,4-butanediol units, 1,2-propanediol units, isosorbide units, and 1,3-propanediol units.

12. The packaging article of claim 11, wherein the polyester has a melt flow index (MFI) when analysis is performed at 145° C. of less than about 5 g/10 min.

13. The packaging article of claim 10, wherein the polyester is present at from about 5 weight parts to about 95 weight parts, and the composition further comprises at least one component selected from the group consisting of from about 0.1 weight parts to about 20 weight parts of a plasticizer, from about 0.1 weight parts to about 1 weight part of a pigment, and from about 0.002 weight parts to about 1 weight part of an antioxidant.

14. The packaging article of claim 13, wherein the polyester is present at from about 5 weight parts to about 90 weight parts, and the composition further comprises from about 10 weight parts to about 95 weight parts of a second polymer selected from the group consisting of starch, polylactic acid, and polylactide.

15. The packaging article of claim 14, wherein the polyester is present at about 50 weight parts and the second polymer is polylactide and is present at about 50 weight parts.

16. The packaging article of claim 10, wherein the packaging article is selected from the group consisting of a plate, a tray, a bowl, a cup, a bowl lid, a cup lid, a fork, a spoon, a knife, a jewel case, and a packaging article.

17. A method of manufacturing a composition comprising a polyester comprising about 1 mole part diol units and from about 0.98 mole parts fumaric acid units to about 1.01 mole parts fumaric acid units, the method comprising:
combining about 1 mole part diol, from about 0.98 mole parts fumaric acid to about 1.01 mole parts fumaric acid, and from about 0.0002 mole parts to about 0.0020 mole parts of a polyesterfication catalyst, to yield a combination of diol and fumaric acid;
maintaining the combination of diol and fumaric acid under an inert atmosphere at a temperature from about 130° C. to about 190° C. for at least about 2 hr, to yield a molten combination;
maintaining the molten combination under vacuum at a temperature from about 130° C. to about 190° C. for at least about 18 hr, to yield a molten polyester; and
cooling the molten polyester, to yield the polyester.

18. The method of claim 17, wherein the diol is selected from the group consisting of ethylene glycol, 1,4-butanediol, 1,2-propanediol, isosorbide, and 1,3-propanediol.

19. The method of claim 17, wherein the polyesterification catalyst is selected from the group consisting of tin(II) chloride, tin(II) octonate, n-butyl stannoic acid, sulfuric acid, p-toluene sulfonic acid, and mixtures thereof.

20. The method of claim 17, further comprising extruding the polyester, to yield a sheet of the composition.

21. The method of claim 20, wherein the extruding step further comprises coextruding with the polyester a second polymer selected from the group consisting of starch, polylactic acid, and polylactide.

22. The method of claim 20, wherein the extruding step further comprises coextruding with the polyester at least one component selected from the group consisting of a plasticizer, a pigment, and an antioxidant.

23. The method of claim 20, further comprising molding the sheet of the composition, wherein the sheet is molded to a form selected from the group consisting of a plate, a tray, a bowl, a cup, a bowl lid, a cup lid, a fork, a spoon, a knife, a jewel case, and a packaging article.

24. The method of claim 17, wherein the diol and the fumaric acid are derived from biomass.

25. The method of claim 17, further comprising reacting the molten polyester with a chain extending agent selected from the group consisting of isocyanates, epoxides, acyl chlorides, anhydrides, acrylics, aziridines, phosphate esters, multivalent metals, polyacids, polyols, oxazolines, polymers or copolymers containing any of the foregoing functional groups, and mixtures thereof.

26. The method of claim 25, wherein the chain extending agent is selected from the group consisting of 4,4′-methylene diphenyl diisocyanate (MDI), toluene diisocyanate (TDI), hexamethylene diisocyanate (HDI or HDMI), isophorone diisocyanate (IPDI), lysine diisocyanate (LDI), trimethylxylene diisocyanate (TMDI or TMXDI), polyisocyanate compounds, and mixtures thereof.
